(19) United States
(12) Patent Application Publication
(10) Pub. No.: US 2011/0112666 A1
(43) Pub. Date: May 12, 2011

(54) System and Method for Interfacing an Audio Connector and Jack at an Information Handling System

(76) Inventors: Brian McFarland, Georgetown, TX (US); Ching-Chieh Lin, Taipei (TW); David Konetski, Austin, TX (US); Douglas Peeler, Austin, TX (US)

(21) Appl. No.: 12/616,215

(22) Filed: Nov. 11, 2009

(51) Int. Cl. G06F 17/00

(52) U.S. Cl. 700/94

(57) ABSTRACT

An analog connector disposed at an information handling system housing accepts both analog audio information and digital audio information at plural connection surfaces by accepting either an analog or digital jack. An audio subsystem of the information handling system manages audio information at the connector by selectively configuring to handle analog or digital signals based upon the type of jack insert into the connector. Selection of analog or digital management is performed manually through a user interface or automatically by detection of the type of jack inserted in the connector. In one embodiment, a four pole analog connector accepts a four pole digital jack that communicates serial data through a pole connection surface instead of analog signals.

### BACKGROUND OF THE INVENTION

1. Field of the Invention

The present invention relates in general to the field of information handling system audio devices, and more particularly to a system and method for interfacing an audio connector and jack at an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have become a convenient resource for communicating audiovisual information. For example, end users have microphones and video cameras that interface with information handling systems to support voice and video chat through networks, such as the Internet. Information handling systems have also become a convenient resource for generating and storing audiovisual information, such as home videos. Traditionally audio visual information is gathered by analog devices that store the information as analog signals and then provide the analog signals to an information handling system or peripheral for conversion into digital signals. As processing components have become more powerful and specialized, conversion into digital information has tended to occur at the gathering of the audio visual information instead of at the information handling system. One example of this is the collection of audio information with a microphone at an information handling system. Sound energy is captured by a mechanical device and turned into electrical signals. The electrical signals travel through a cable to an analog microphone jack that plugs into an analog connector at the information handling system. The analog signals then travel from the analog connector to an analog-to-digital converter in the information handling system for conversion into digital data. Newer microphones have migrated the analog-to-digital converter to the microphone device itself so that digital information is communicated through the cable to the information handling system.

One of the difficulties that has arisen with the use of digital microphones that send digital signals to an information handling system is that the digital signals typically are communicated through a specialized connector, such as USB or a 1394 Firewire. Specialized connectors tend to increase the expense of the microphone and also increase the complexity that an end user faces in loading and using the microphone and its driver on the information handling system. A USB array microphone that provides a high quality array experience can present a considerable expense to an end user. As voice applications increase in popularity among information handling system users, increasing numbers of end users will seek high quality sound capture from microphones. High Definition Audio (HDA) codec suppliers are including support for digital microphones, however, no standardized connectors are established to interface a digital microphone with an information handling system with support for digital microphones.

### SUMMARY OF THE INVENTION

Therefore a need has arisen for a system and method which interfaces a digital microphone with an information handling system in a standardized manner.

In accordance with the present invention, a system and method are provided which substantially reduce the disadvantages and problems associated with previous methods and systems for interfacing a digital microphone with an information handling system. A jack of a digital audio device communicates digital audio information through an analog connector so that the analog connector supports communication of both digital and analog audio information.

More specifically, an information handling system processes information with plural processing components disposed in a housing, such as a CPU, RAM, a hard disk drive and a chipset. The processing components process and store audio information in a digital format made of ones and zeros. An audio subsystem includes a CODEC that accepts analog audio information that represents audio sounds as electrical signals and converts the analog audio information into digital audio information for use by the processing components. The audio subsystem also accepts digital audio information in a digital format received from a digital device, such as a digital microphone. Audio information is communicated through a jack that couples to an analog connector of the information handling system. A detection module of the information handling system detects the presence of a digital or analog jack in the analog connector and selectively sends the signal to appropriate pins of the CODEC. A serial digital link, clock and power are sent through analog connection surfaces of the analog connector so that the CODEC is able to identify and use the digital audio information.

The present invention provides a number of important technical advantages. One example of an important technical advantage is that a single connector at an information handling system will interface with either an analog or a digital microphone. Automatic detection by jack sensing from a codec of the information handling system supports automated analog or digital connector functionality so that an end user may select either an analog or digital microphone for use at the same connector. Automatic detection is supported with logic at the codec without the use of a MUX or other detection circuitry. Using a standardized jack connector provides a positive end user experience so that interaction with the information handling system remains consistent for conventional analog microphones as well as digital microphones. In addition, a single connector for both analog and digital microphones takes up less space at an information handling system than separate connectors, thus helping to minimize the size of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having an analog audio connector that accepts a digital audio jack; and

FIG. 2 depicts a circuit diagram of an analog connector and audio subsystem with analog and digital audio functionality;

FIG. 3 depicts a circuit block diagram of an analog connector supporting digital but not analog functionality; and

FIG. 4 depicts a circuit block diagram of an analog connector supporting both digital and analog functionality.

### DETAILED DESCRIPTION

Dual use of an analog audio connector for both analog and digital audio information communication at an information handling system simplifies end user interaction with the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

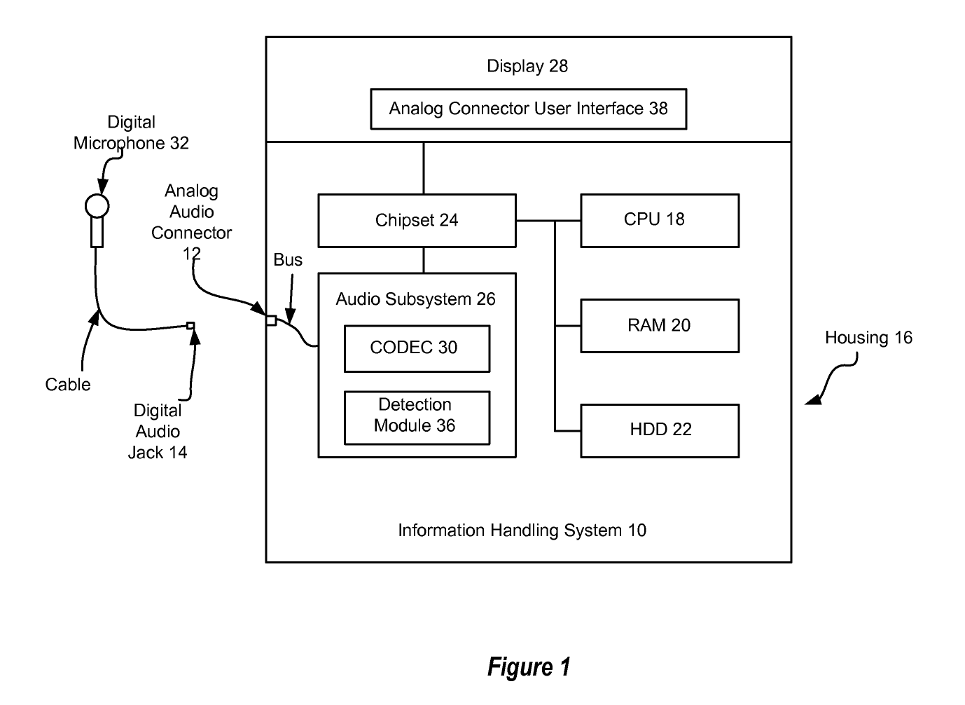

Referring now to FIG. 1, a block diagram depicts an information handling system 10 having an analog audio connector 12 that accepts a digital audio jack 14. Information handling system 10 is built with plural processing components disposed in a housing 16, such as a CPU 18, RAM 20, a hard disk drive 22 and a chipset 24. The processing components cooperate to process information, such as audio information presented by an audio subsystem 26 and visual information presented by a display 28. Audio subsystem 26 includes one or more CODECs 30 that manage conversion of information between analog and digital formats. For example, an analog audio signal generally represents sounds by varying the current or voltage of an analog electrical signal. In contrast, digital audio information generally represents sounds by sampling an analog audio signal and assigning numerical values to the analog audio signals that are then represented by a zero or one value. Typically, an electromechanical microphone captures sound energy as analog electrical signals. An analog microphone sends the analog signals to an information handling system where the analog signals are sampled by an analog-to-digital CODEC for transformation to digital information usable by processors. A digital microphone performs the conversion to digital information at the microphone device itself and sends the digital audio information to the information handling system in a digital format. To play the audio information, a digital-to-analog CODEC transforms the digital audio information to analog signals that an electromechanical device applies to make audible sounds.

Information handling system 10 depicted as an example embodiment in FIG. 1 uses analog audio connector 12 to interface with either an analog audio device or a digital audio device. For instance, a digital microphone 32 captures sounds and converts the sounds into digital audio information represented by zeros and ones. The digital audio information is communicated through cable 34, such as by using a serial link, to a digital audio jack 14 and into information handling system 10 at analog audio connector 12. CODEC 30 recognizes the audio information as having a digital form that does not need transformation so that audio subsystem 26 provides the digital audio information to chipset 24 for use by the processing components. If an analog microphone with an analog audio jack interfaces with analog audio connector 12, then CODEC 30 samples the analog audio information to transform it into digital audio information. Audio subsystem 26 determines whether the audio information arrives in an analog or digital form with a detection module 36. For instance, detection module 36 samples the impedance of a jack upon insertion into analog audio connector 12 to identify the jack as either analog or digital. Alternatively, an analog connector user interface 38 allows an end user to manually select whether a jack is analog or digital. Based upon the detected or input identification of the jack as analog or digital, CODEC 30 determines whether or not to perform sampling. In alternative embodiments, other types of audio devices may be supported by a dual function connector 12. For example, audio subsystem 26 may output analog or digital audio information to speakers based upon the type of jack inserted into analog audio connector 12.

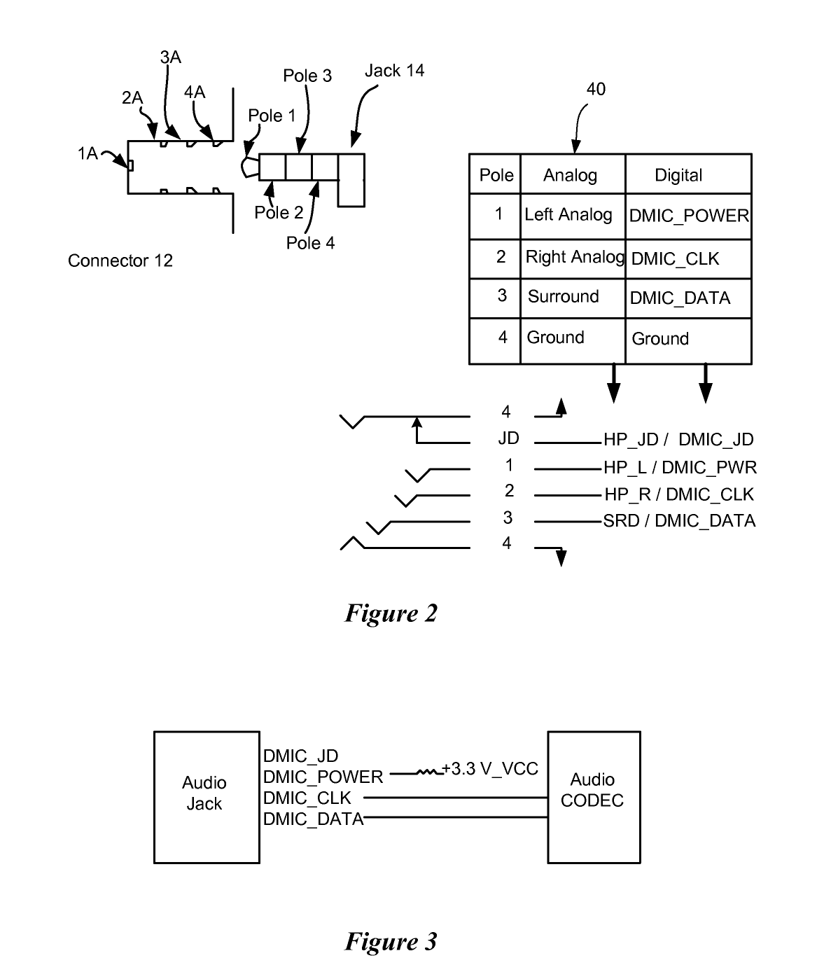

Referring now to FIG. 2, a circuit block diagram depicts an analog connector 12 and audio subsystem 26 with analog and digital audio functionality. Connector 12 and jack 14 have a four pole configuration used for standardized communication of analog audio information. Table 40 depicts the relationship between the communication of analog versus digital information at each of the four poles numbered sequentially from the tip as 1, 2, 3 and 4. When inserted in connector 12, each pole 1, 2, 3 and 4 aligns with an associated connection surface depicted as 1A, 2A, 3A and 4A. In an analog configuration, pole 1 provides a left analog audio signal, pole 2 provides a right analog audio signal, pole 3 provides a surround left or right signal and pole 4 provides a ground, which also allows a measurement of impedance for determining the type of jack 14 inserted in connector 12. In a digital configuration, pole 1 provides power to operate the digital microphone, pole 2 provides a clock signal, pole 3 provides digital audio information with a serial link and pole 4 provides a ground. In an alternative embodiment, a three pole jack and connector supports both analog and digital signals by sending a clock signal through a common connection surface with power. In alternative configurations, different arrangements of digital information for communication through various connection surfaces may be selected, such as by changing the digital data to pole 1 or pole 2.

Referring now to FIG. 3, a circuit block diagram depicts an analog connector supporting digital but not analog functionality. In the single function embodiment of FIG. 3, CODEC 30 only accepts digital audio information and thus need not determine if analog audio information is present. Sending the digital audio information through a connector having an analog configuration provides an end user with a familiar device that works similar to existing analog devices so that end users are able to adapt to digital microphone use without difficulty. Some examples of digital microphones that might communicate through an analog connector are the SPM0205HD4 by Knowles Acoustics or the AKU2000 by Akustica. In the example embodiment depicted by FIG. 3, power is provided to the digital microphone by sending 3.3 mA through a 1K ohm resistor.

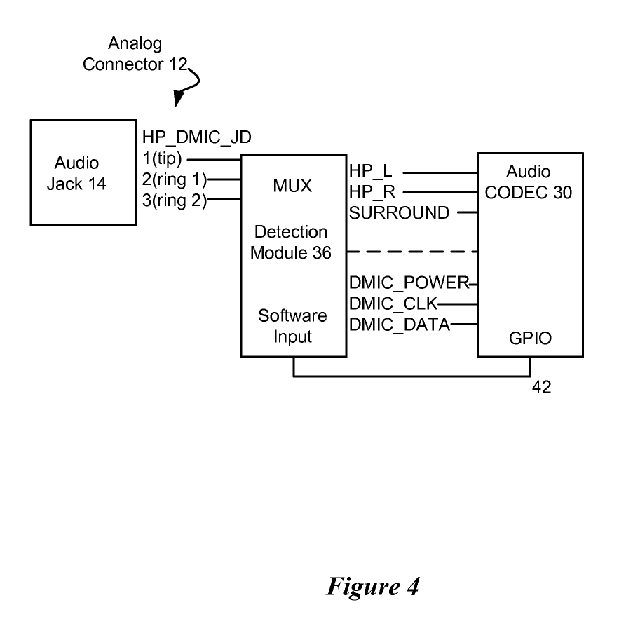

Referring now to FIG. 4, a circuit block diagram depicts an analog connector 12 supporting both digital and analog functionality. Audio jack 14 couples to connector 12 to interface a microphone with detection module 36. Detection module 36 includes a MUX that selectively interfaces signals provided from audio jack 14 with either an analog portion or digital portion of audio CODEC 30. If detection module 36 detects an analog audio signal input, such as by measuring impedance at ground to determine if an analog or digital jack 14 is present, then the MUX of detection module 36 selects to send signals to pins of CODEC 30 for analog left, right and surround signals. If detection module 36 detects a digital audio signal input, then the MUX of detection module 36 selects to send signals to pins of CODEC 30 for power, clock and serial data transfer. A GPIO pin 42 interfaces CODEC 30 with detection module 36 so that a CODEC 30 may force selection of either a digital or analog input into the pins. For example, CODEC 30 forces selection of an analog or digital input if a software interface receives a selection of an analog or digital microphone from an end user.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural processing components disposed in the housing and operable to cooperate to process information;
an audio subsystem interfaced with the processing components and operable to process digital audio information;
an analog connector having plural connection surfaces operable to interface with an analog jack; and
a bus interfacing the analog connector and the audio subsystem;
wherein the analog connector connection surfaces align with a digital jack of an audio device to communicate digital audio information between the digital jack through the analog connector and bus and with the audio subsystem.

2. The information handling system of claim 1 further comprising a digital microphone having a digital jack operable to interface with the analog connection surfaces, the digital microphone having a processor operable to convert detected sounds into digital audio information and to communicate the digital audio information to the digital jack.

3. The information handling system of claim 1 wherein the audio subsystem is further operable to accept analog audio signals and to convert the analog audio signals into digital audio information, the information handling system further comprising a detection module operable to determine if a jack interfaced with the analog connector has digital audio information or analog audio signals and to set the audio subsystem to accept the detected of the digital audio information or the analog audio signals.

4. The information handling system of claim 3 wherein the detection module comprises an impedance sensor.

5. The information handling system of claim 1 wherein the audio subsystem is further operable to accept analog audio signals and to convert the analog audio signals into digital audio information, the information handling system further comprising a mode selection module operable to accept an end user selection that a jack interfaced with the analog connector has digital audio information or analog audio signals and to set the audio subsystem to accept the selection of the digital audio information or the analog audio signals.

6. The information handling system of claim 5 wherein the mode selection module comprises a Mux interfaced with the audio subsystem to selectively direct signals from the connector to analog or digital portions of the audio subsystem.

7. The information handling system of claim 1 wherein the analog connector comprises a pole divided into four connection surfaces, the four connections surfaces designated for a left analog signal, right analog signal, surround signal and ground.

8. The information handling system of claim 7 wherein the left analog signal connection surface provides power to run a digital microphone.

9. The information handling system of claim 7 wherein the right analog signal connection surface provides a clock signal.

10. The information handling system of claim 7 wherein the surround signal connection surface provides serial data.

11. A method for communicating digital audio information at an information handling system, the method comprising:
connecting a digital jack to an analog connector of the information handling system;
communicating digital audio information between the digital jack and analog connection surfaces of the analog connector; and
applying the digital audio information at an audio subsystem of the information handling system.

12. The method of claim 11 wherein communicating digital audio information further comprises:
generating the digital audio information at a digital microphone; and
sending the digital audio information from the digital microphone to the digital jack.

13. The method of claim 11 wherein the analog connection surface comprises a surface that accepts an analog audio signal and the digital audio information provided at the analog audio signal connection surface comprises a clock.

14. The method of claim 11 wherein the analog connection surface comprises a surface that accepts an analog audio signal and the digital audio information provided at the analog audio signal connection surface comprises serial data.

15. The method of claim 11 further comprising providing power at the digital jack and one analog connection surface of the analog connector for use by a digital audio device located a distance away from the information handling system.

16. The method of claim 15 further comprising sending a clock signal with the power.

17. The method of claim 11 further comprising:
detecting whether a jack inserted in the analog connector is an analog jack or a digital jack; and
automatically configuring the audio subsystem to receive analog audio information if an analog jack is connected and to receive digital audio information if a digital jack is connected.

18. A system for communicating audio information with an information handling system, the system comprising:
an analog connector having plural connection surfaces disposed to align with an analog jack inserted in the analog connector, the connection surfaces for supporting communication of analog audio information with an information handling system; and
an audio subsystem interfaced with the analog connector, the analog subsystem operable to selectively accept analog or digital audio information from the connection surfaces.

19. The system of claim 18 further comprising a detection module interfaced with the audio subsystem and operable to detect whether analog or digital audio information is present at the analog connector and to automatically selectively accept the detected analog or digital audio information.

20. The system of claim 19 wherein the detection module detects analog or digital audio information by detecting impedance of a jack inserted in the analog connector.
